(19) United States
(12) Patent Application Publication
(10) Pub. No.: US 2014/0048475 A1
(43) Pub. Date: Feb. 20, 2014

(54) Vessels for Contaminated Liquids

(71) Applicant: Cintec International Ltd, Newport (GB)

(72) Inventor: Peter James, Shirenewton (GB)

(73) Assignee: Cintec International Ltd, Newport (GB)

(21) Appl. No.: 13/967,457

(22) Filed: Aug. 15, 2013

(30) Foreign Application Priority Data
Aug. 16, 2012 (GB) 1214624.7

(51) Int. Cl. C02F 1/00

(52) U.S. Cl. CPC C02F 1/001
USPC 210/477

(57) ABSTRACT

A relocatable separation tank for liquids containing particulate or solid matter (waste) is disclosed. The tank includes a container having a base and upstanding wall or walls. A liquid permeable staging is overlaid on the base to define a liquid reservoir between the staging and the base. The container further includes at least one bag having a liquid permeable base, the bag being mounted on the staging for receiving the waste containing liquid and retaining the waste whilst allowing liquid to flow into the reservoir.

### FIELD OF THE INVENTION

This invention relates to a relocatable vessel for liquids containing particulate or solid matter (waste).

### BACKGROUND OF THE INVENTION

There are many industries which produce waste water, or other liquids, which contains waste that is environmentally undesirable and needs to be separated out from the liquid for treatment and/or disposal.

One such industry is the fracking industry, where operational sites can be set up in remote locations and may be only operational for a limited period. For example, in northern Canada, the operating window may only consist of a few months in a year. Existing lagoons for containing the water liquids of fracking, are structurally very heavy and have to be mounted on steel foundations, the construction of which can in turn use up a significant portion of the operational window in their construction.

The captured liquid is then usually placed in tankers and driven considerable distances to treatment plants. Allegedly mobile arrangements have been suggested, but they are of significant expense and weight and seek to carry out decontamination on site.

The Applicants have developed a system which, in many cases, is relatively inexpensive, quick to erect, and may reduce the number of lorry journeys significantly, if it is possible to dispose of the liquid on site, after the waste has been removed.

### SUMMARY

Thus, the invention includes a relocatable separation tank for liquids containing particulate or solid matter (waste) including a container having a base and upstanding wall or walls; liquid permeable staging overlying the base to define a liquid reservoir between the staging and the base and at least one bag having a liquid permeable base, the bag being mounted on the staging for receiving the waste containing liquid and retaining the waste whilst allowing liquid to flow into the reservoir.

It will be appreciated that this construction is the reverse of many traditional separation tanks or lagoons in which the solid material is left to settle and the liquid retained on the top. Instead, in the Applicant's invention, the solid material or waste is retained in the bag, which can be easily removed and replaced. Depending on the nature of the product it can then be taken for further treatment or disposal. The approach could have a wide range of uses. Simply by way of example, it could provide a significantly improved method of handling slurry, for example, from an automatic dairy unit. The liquid content of the slurry could be pumped from the reservoir into an appropriate tank, whilst the waste could be separated for composting and the like. This will be particularly advantageous where the application of slurry onto fields has become more restricted for health and safety reasons.

Conveniently, the reservoir has a liquid outlet, which may be attached to a suitable pump and/or storage tank.

It is particularly preferred that at least the walls of the container are inflatable and conveniently they may be made of drop stitch material.

The staging may be formed from pallets for example waste pallets.

The bags are preferably formed so that they stand open when sat on their base and preferably the or each bag is provided with carrying handles and/or lifting points. The kind of bag used in builders' merchants for transporting sand and the like, is ideally suitable, although the bags may need to be shaped to fit within the cross-section of the container.

The container may have any suitable cross-section but, for reasons of structural integrity, a hexagonal shape is particularly preferred. This may require the provision of specially shaped bags.

It will be understood that when the liquid has drained out of the bags, they can be readily lifted into lorries, whilst the liquid is disposed of locally. There is, therefore, a significant reduction in vehicle journeys.

Further, when the structure is inflatable, in particular, it can be erected very quickly on site and, at best, only limited foundations are required. It may, for example, only be necessary to carry out a soil compaction.

It will also be seen that the use of pallets and bags, such as fibrous bags, mean that the cost is unusually low.

Although the invention has been described above, it is to be understood that it includes any inventive combination of the features set out above or in the following description.

### BRIEF DESCRIPTION OF THE DRAWINGS

The invention may be performed in various ways and a specific embodiment will now be described by way of example, with reference to the accompanying drawings, in which:

FIG. 1 is a view from above of a container;

FIG. 2 is a section on the line A-A of FIG. 1 with staging and bags added; and

FIG. 3 is a corresponding view to FIG. 2 but with the bags filled and the container rotated to show the pipe in section.

### DETAILED DESCRIPTION

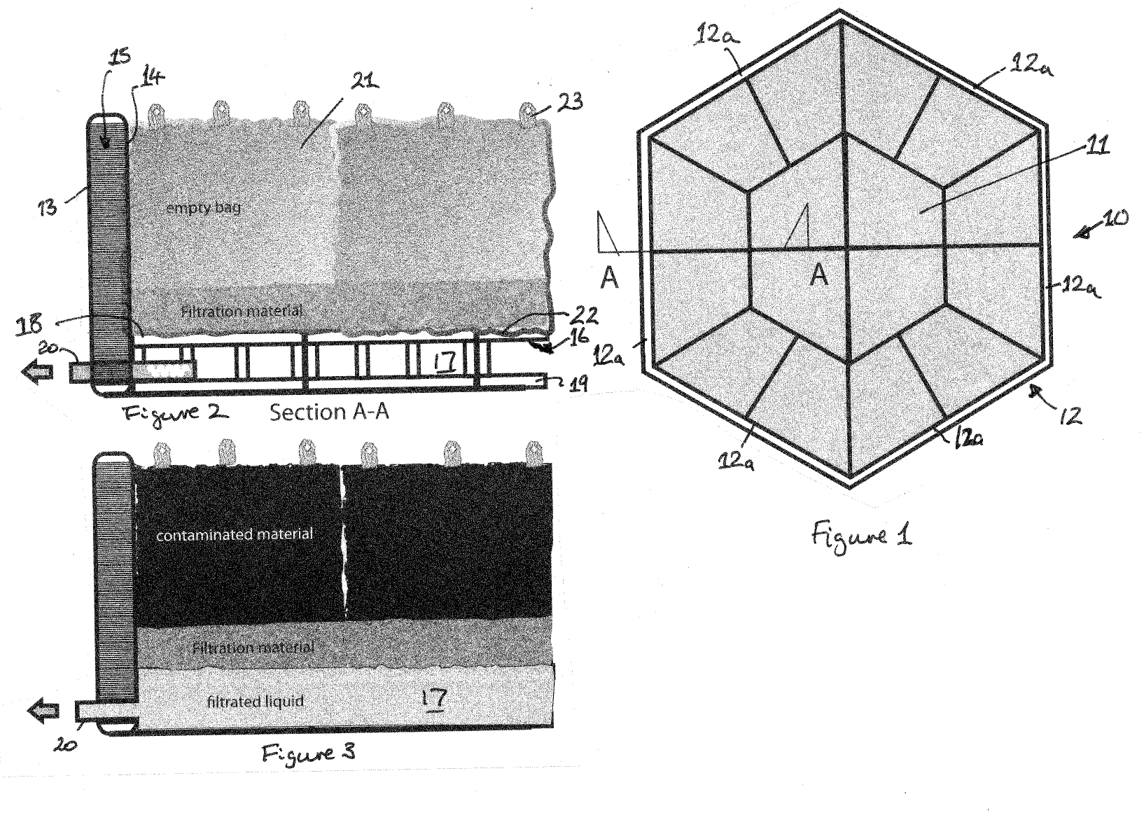

As can be seen in FIG. 1, a container, generally indicated at 10, includes a base 11 and an upstanding wall 12 including wall segments 12A.

As can be seen in FIGS. 2 and 3, the wall 12 is preferably formed of drop stitch material in which the outer skin 13 is connected to the inner skin 14 by cross-linked filaments 15. As is known, such structures are inflatable and can provide a strong rigid wall when so inflated.

As can best be seen in FIG. 2 staging, generally indicated at 16, is placed on the base 11 to define a reservoir 17 between the upper surface of the staging 18 and the base 11. Conveniently, the staging 16 is formed by one or more wooden or plastic pallets, which themselves are often a waste product of industry. A pipe 20 provides a liquid outlet. Fibrous bags 21 can then be placed on the surface 18 to be supported above the reservoir 17. These bags are, conveniently, of the type used by builders' merchants. It is necessary that their bases 22 are liquid permeable and desirably they have carrying handles or lifting locations such as are illustrated at 23.

In use, the liquid containing waste is placed into one or more bags 21. The liquid then passes through the base 22 into the reservoir 17 where it can be removed either on a continuous basis or from time to time. In many instances, the liquid will be sufficiently clean for disposal on site with or without further treatment processes. For example, in fracking, it may be re-injected into the ground in the fracking process.

In other arrangements, such as the slurry example discussed above, where the waste material may be usable on site but the liquid is regarded as contaminated, the substantial reduction in volume will reduce the size of the storage facility that is required. Currently, on large dairy farms a very substantial lagoon is required and can be vulnerable to damage by burrowing animals, in particular badgers.

Although it is particularly preferred to use waste pallets and the like for the staging, it will be understood that bespoke staging could be provided. For example it could be in the form of a metal table having a perforate surface.

The cross-sectional shape of the container may be varied as is appropriate to the use, the size and the proposed location. Ideally the container will be of circular cross section but wherein cross-linked material is used it is easier to make straight-sided panels and so containers with four or more sides may be sued. The containers may be of substantial capacity, for example between 25,000 and 100,000 litres. A container of 64,000 litres capacity has been tested and retained water satisfactorily. The container walls may, for example, be between 1 and 2 metres high.

The uninflated containers can be handled by two men and erected, with a suitable air pump, in half an hour. This is in contrast to the substantial erection time for existing steel containers which are, in any case, simply reservoirs.

One or more containers may be surrounded by a berm.

1. A relocatable separation tank for liquids containing particulate or solid matter (waste) including a container having a base and upstanding wall or walls; liquid permeable staging overlying the base to define a liquid reservoir between the staging and the base and at least one bag having a liquid permeable base, the bag being mounted on the staging for receiving the waste containing liquid and retaining the waste whilst allowing liquid to flow into the reservoir.

2. A tank as claimed in claim 1, including a liquid outlet for the reservoir.

3. A tank as claimed in claim 1, wherein at least the container walls are inflatable.

4. A tank as claimed in claim 3, wherein the walls are made of a drop stitch material.

5. A tank as claimed in claim 1, wherein the staging is formed from one or more pallets.

6. A tank as claimed in claim 1, wherein the or each bag is constructed to stand open on its base.

7. A tank as claimed in claim 1, wherein the or each bag is provided with carrying handles and/or lifting points.
